(19) United States
(12) Patent Application Publication
(10) Pub. No.: US 2007/0119836 A1
(43) Pub. Date: May 31, 2007

(54) Method and apparatus for focusing a beam from an excimer laser to form a line of light on a substrate

(76) Inventor: Thomas Schroeder, Goettingen (DE)

Correspondence Address: STALLMAN & POLLOCK LLP, 353 SACRAMENTO STREET, SUITE 2200, SAN FRANCISCO, CA, 94111, US

(21) Appl. No.: 11/493,317

(22) Filed: Jul. 26, 2006

Related U.S. Application Data
(60) Provisional application No. 60/740,476, filed on Nov. 29, 2005.

(51) Int. Cl. B23K 26/06

(52) U.S. Cl. 219/121.75

(57) ABSTRACT

A substantially collimated, plane-polarized, excimer laser beam is projected onto a substrate by a cylindrical lens arranged at non-normal incidence to the beam. The lens projects the beam onto a substrate to form a line of light on the substrate. The line of light has a length greater than the height of the beam and a width length less than the width of the beam. By selecting an appropriate incidence angle and polarization-plane alignment of the beam with the lens, total light reflection losses from the lens and the substrate can be minimized.

### PRIORITY

This application claims priority to U.S. Provisional Application Ser. No. 60/740,476, filed Nov. 29, 2005, the disclosure of which is incorporated herein by reference.

### TECHNICAL FIELD OF THE INVENTION

The present invention general to optical arrangements for focusing a laser beam to form a line of light on a substrate. The invention relates in particular to focusing an excimer laser beam as a line of light on a silicon substrate.

### DISCUSSION OF BACKGROUND ART

There are several laser applications wherein it is necessary to focus laser radiation on a substrate in the form of a line of light.

A common approach to focusing the laser radiation to form a line of light is to focus a laser beam using an anamorphic optical system which has different magnification in two transverse axes perpendicular to each other. This can include an optical system in which the magnification in one of the axes is greater than unity and the magnification in the other axis is less than unity. Typically such an optical system includes at least three refractive optical elements, at least one of which is a cylindrical optical element or an anamorphic optical element. Laser radiation focused by such an optical system is usually incident, generally, normally on the optical elements. The term “generally normally”, here, meaning that the general direction of propagation through the elements is at normal incidence thereto, while a laser beam entering the system, leaving the system and between elements of the system may be collimated, converging, or diverging, depending on the laser delivering the beam and the configuration of the optical elements.

Elements of such an optical system are preferably antireflection coated to reduce Fresnel reflection losses at surfaces of the optical elements. An optical system is typically more expensive the more optical elements are included in the system. Providing optical coatings for the elements adds cost. This is particularly true of optical systems for focusing ultraviolet (UV) laser radiation from excimer lasers. Such lasers can provide radiation at wavelengths less than 200 nanometers (nm) for which optical systems are preferably made from crystalline materials such as calcium fluoride (CaF₂). Optical coatings on such crystalline substrates are less durable than comparable coatings on glass substrates or fused silica substrates. Such coatings can also be prone to degradation by the ultraviolet radiation itself.

A general problem encountered in focusing ultraviolet radiation on a silicon (Si) substrate is that the relatively high refractive index (about 3.45 at a wavelength of 200 nm) of the silicon can cause about 30% of the radiation incident thereon at near normal incidence to be lost by Fresnel reflection from the surface of the substrate. There is a need for a method and apparatus for focusing UV radiation on a substrate that does not require a multi-element optical system and that can avoid radiation loss at the substrate due to Fresnel reflections.

### SUMMARY OF THE INVENTION

The present invention is directed to method and apparatus for projecting a beam from an excimer laser to form a line of light on a substrate, in one aspect the method of the present invention comprises providing a substantially collimated, plane polarized excimer laser beam. The collimated, plane-polarized beam is projected onto the substrate by a cylindrical lens arranged at non-normal incidence to the beam to form the line of light on the substrate beam. Because of the non-normal incidence of the beam on the lens, the line of light has a length greater than the height of the beam. The projected line has a width less than the width of the beam.

By selecting an appropriate incidence angle and polarization-plane alignment of the beam with the lens, total light reflection losses from the lens and the substrate can be minimized. In one example wherein the lens is a calcium fluoride lens and the substrate is a silicon substrate, an incidence angle of about 640 can provide a line length about 2.4 times greater than the beam height and total reflection losses of only about 7%. In another example, wherein the lens is furnished with antireflection coatings, an incidence angle of about 73.8° degrees can provide a line length about 3.6 times the beam height with near zero total reflection losses.

### BRIEF DESCRIPTION OF THE DRAWINGS

The accompanying drawings, which are incorporated in and constitute a part of the specification, schematically illustrate a preferred embodiment of the present invention, and together with the general description given above and the detailed description of the preferred embodiment given below, serve to explain the principles of the present invention.

FIG. 1A is a long-axis view schematically illustrating one preferred embodiment of a method and apparatus in accordance with the present invention including a cylindrical lens arranged to focus a beam from an excimer laser to form a line of light on a substrate, the beam being incident on the lens at non-normal incidence and the line of light correspondingly having a length greater than the long-axis height of the beam by a stretching factor depending on the angle of incidence.

FIG. 1B is a short-axis view schematically illustrating further detail of the apparatus of FIG. 1A.

FIG. 2 is a graph schematically illustrating calculated reflection loss as a function of incidence angle for the lens, a silicon substrate, and for the total of reflection losses from the lens and the substrate, in one example of the apparatus of FIGS. 1A and 1B wherein the lens is made from calcium fluoride and the substrate is a silicon substrate.

FIG. 3 is a graph schematically illustrating calculated reflection loss, with and without antireflection coatings on the lens, as a function of the stretching factor for the example of FIG. 2

### DETAILED DESCRIPTION OF THE INVENTION

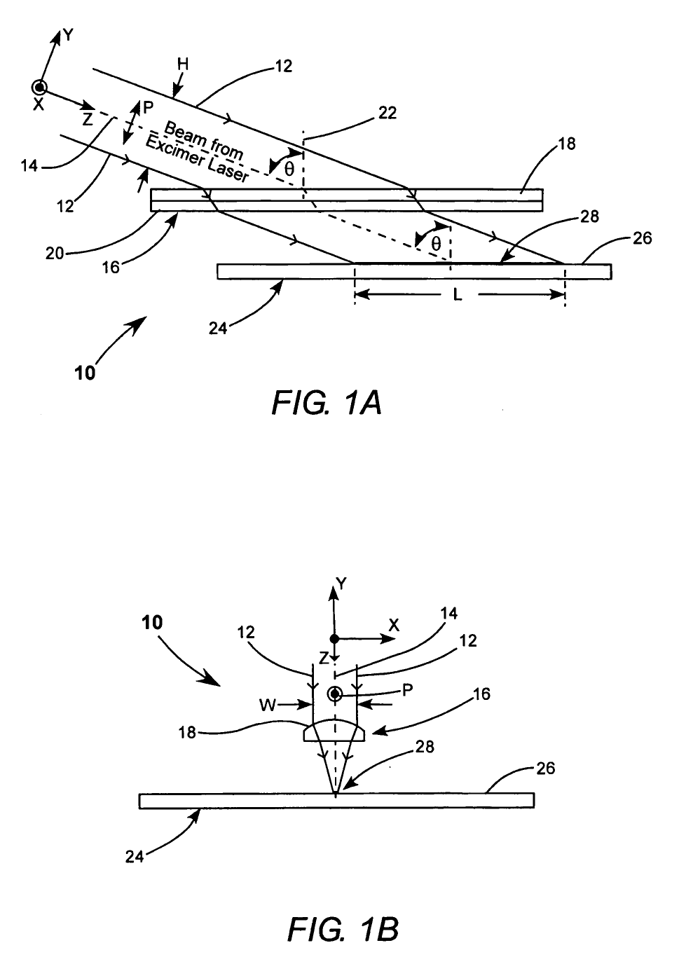

Referring now to the drawings FIG. 1A and FIG. 1B schematically illustrates one preferred embodiment of a method and apparatus 10 in accordance with the present invention. A polarized beam from an excimer laser (not shown) is depicted in FIGS. 1A and 1B by bounding rays 12. The beam has an elongated cross-section (which is usual in a beam from a high power excimer laser) characterized by a height H (see FIG. 1A) and a width W (see FIG. 1B). By way of example, a beam delivered by a LambdaSTEEL® excimer laser manufactured by Lamba Physik AG of Gottingen, Germany, the assignee of the present invention, delivers a beam having a height of about 40 millimeters (mm) and a width of about 15 mm. Such an excimer laser beam is usually characterized by practitioners of the art as having a “long-axis” aligned with the height direction of the beam, and a “short-axis” aligned with the width direction of the beam. In FIGS. 1A and 1B, the long-axis is designated as a Cartesian Y-axis and the short axis is designated as a Cartesian X-axis (perpendicular to the Y-axis). The general direction of propagation is along the Z-axis mutually perpendicular to the X and Y-axes and indicated by dashed line 14. Beam 14 is substantially collimated in both axes, the term substantially here meaning that the beam is either collimated or has a sufficiently low divergence that it can be treated from a design standpoint, without significant error, as being collimated.

The beam may be received directly from the excimer laser if the laser output has an inherently low divergence (good beam quality). The beam is preferably delivered as a plane-polarized beam with the electric vector (polarization plane) aligned parallel to the long-axis as indicated in FIG. 1A by arrows P. Those skilled in the art will recognize that a plane-polarized beam can be delivered by a laser by including one or more refractive surfaces in the resonator of the laser at non-normal incidence to radiation circulating in the resonator. By way of example, in an excimer laser in which lasing gas is confined in a gas chamber, Brewster angled windows provided on the gas chamber can be used to polarize the circulating (and delivered) radiation.

Apparatus 10 includes a plano-convex cylindrical lens 16 having a convex upper surface 18 and a plane lower surface 20. Those skilled in the art will recognize that term “cylindrical”, as used and in the appended claims means that the lens has power in one transverse axis only. Lens 16 has positive power in the short-axis (X-axis) and zero optical power in the long-axis (Y-axis). A substrate 24 is located below lens 16, with an upper surface 26 of the substrate parallel to lower surface 20 of the lens. Surface 26 is preferably located at about a back focal-length of lens 16 from surface 20 of the lens.

Beam 12 is incident on lens 16 at an angle θ to a normal 22 to the lens. As can be seen in FIG. 1A, the normal lies in a plane parallel to the long axis of the lens 16. Preferably incidence angle θ is greater than 45°, and more preferably between about 45° and 85°. Criteria for selecting a particular value for incidence angle θ are discussed further hereinbelow. As lens 16 has zero long-axis optical power, beam 12 remains substantially collimated in the long-axis on exiting the lens and is incident on surface 26 of substrate 24 at the incidence angle θ. In the short-axis, the beam is focused by the lens onto surface 26 of the substrate. A result of this is that the laser beam is formed into a line of light (designated by a bold line 28 in FIGS. 1A and 1B) having a length L. Length L is longer than the long-axis beam-height H by a stretching factor S dependent on angle of incidence θ. More specifically, stretching factor S is about equal to the cosecant of 90-θ degrees. The width of line 28 will be determined by the quality of beam 12 and the numerical aperture (NA) of the lens, among other factors. By way of example, the width of line 28 may be between about 1.0 and 100.0 micrometers (μm).

In the arrangement of apparatus 10, beam 12 is plane-polarized, with the electric vector P being parallel to the plane of incidence (and parallel to the long-axis plane, or Y-Z plane, of the beam). This polarization alignment with respect to the lens is usually referred to by practitioners of the art as P-polarization. If the angle of incidence of the beam on the lens is the Brewster angle for the material of the lens, the reflection loss from lens surface will be essentially zero. Similarly, if the angle of incidence of the beam on surface 26 of the substrate is the Brewster angle for the material of the substrate, the reflection loss at the substrate surface will be essentially zero. Usually lens 16 will be made from a UV-transmissive material such as fused silica (SiO₂) or calcium fluoride (CaF₂). Such materials have a relatively low refractive index. By way of example, CaF₂ has a refractive index of about 1.5 at a wavelength of about 200 nm. The Brewster angle for CaF₂ at this wavelength is about 56.3°. If substrate 24 were a silicon substrate, the Brewster angle would be about 73.8°, as silicon has a refractive index of about 3.45 at a wavelength of about 200 nm. Clearly, in the arrangement of FIG. 10, it would not be possible to reduce the total reflection loss (from lens surfaces 18 and 20 and substrate surface 26) to zero by means of a P-polarized beam and high angle-of-incidence alone. There is, however, an incidence angle between the Brewster angles for the lens and substrate at which total reflection losses can be minimized.

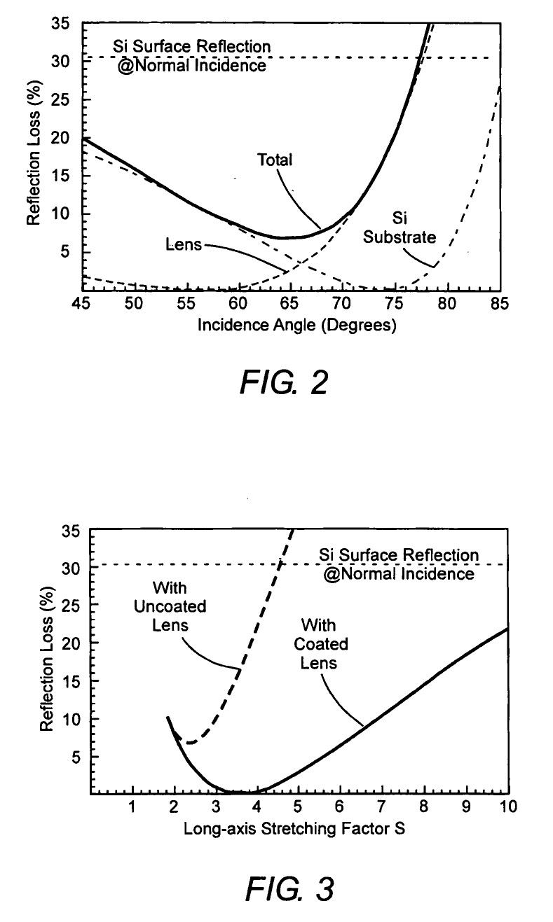

FIG. 2 is a graph schematically illustrating calculated reflection loss as a function of incidence angle for lens 16, substrate surface 26, and for the total of reflection losses from the lens and the substrate surface in one example of the apparatus of FIGS. 1A and 1B wherein the lens is made from calcium fluoride and the substrate is a silicon substrate. Here, it is assumed that the lens surfaces are uncoated, as would be preferred, at least from a cost and durability standpoint. The reflection loss from a silicon surface for light at normal incidence (slightly greater than 30%) is indicated by a horizontal dashed line. It can be seen that while the Brewster angles for the lens and substrate materials are significantly different, there is an intermediate incidence angle of about 63.5 degrees at which the total loss is slightly less than about 7.0%, which is actually less than the loss from two uncoated surfaces of CaF₂ at normal incidence. If the lens were furnished with an anti-reflection coating on each of surfaces, the incidence angle could be increased to the Brewster angle for the substrate and reduce total losses to essentially zero. The antireflection coatings, of course would have to be optimized for P-polarization at the Brewster angle for silicon.

Now, the incidence angle relates directly to the stretching factor as discussed above. Accordingly it is useful to analyze losses as a function of stretching factor. Such an analysis is summarized in FIG. 3, which is a graph schematically illustrating calculated total reflection loss, with and without antireflection coatings on the lens, as a function of the stretching factor for the example of FIG. 2.

It can be seen that in the case where the lens is uncoated, the stretching factor at the lowest total loss is only about 2.4. Even if losses equal to the normal incidence loss from silicon (which would be experienced in prior art multi-element normal incidence projection systems) could be tolerated, the stretching factor could only be increased to 4.6. If lens losses were eliminated by antireflection coatings, then the 4.6 stretching factor could be achieved with total losses of only about 1.5%. For a loss of 7.0% a stretching factor of greater than 6.0 could be achieved. A stretching factor of 10 (at an incidence angle of about 84.3°) could be achieved with total losses less than the 30% loss from a normal incidence reflection from silicon. Generally then, if lens 16 is furnished with antireflection coatings, a range of incidence angles between about 45° and 87° is useful in the apparatus of the present invention. With an uncoated lens a useful range of incidence angles is between about 45° and 75°.

Regarding the durability of antireflection coatings on the lens, it should be noted that, for a fixed power in the beam, the higher the angle of incidence of the beam on the lens, the lower the intensity of radiation incident on the lens. In fact, the intensity would be about inversely proportional to the stretching factor. Because of this, the susceptibility of the coatings to radiation damage would be correspondingly reduced.

If, in any configuration of apparatus 10, the stretching factor available for tolerable losses is not sufficient to provide a line of light of a desired length from a laser-beam, it is possible to “pre-stretch” the laser beam using an afocal long-axis beam expander to increase the long-axis beam height before the beam is incident on lens 16. Such a beam expander may include a long-axis plano-concave cylindrical lens followed by a long-axis plano convex cylindrical lens.

Referring again to FIG. 1A, in order to avoid a need for coating lens 16 and still provide near-zero total reflection loss, it is possible to provide that lens 16 has a radius of curvature that varies progressively along the length of the lens, which makes it necessary to arrange surface 26 of the substrate at an angle to surface 20 of the lens such that short-axis focus is maintained along the line of light on the substrate. By way of example, in the case of a silicon substrate and a CaF₂ lens, if the beam is incident at 56.3° on the lens, the radius of curvature variation can be selected such that the substrate surface must be inclined at 17.5° to the lens to maintain short-axis focus along the line. This makes the beam after leaving the lens incident on the substrate at 73.8°, i.e., the Brewster angle for silicon. The stretching factor is determined by the incidence angle on the substrate and would be about 3.6 as noted above.

In summary present invention is described above in terms of a preferred and other embodiments. The invention is not limited, however, to the embodiments described and depicted. Rather, the invention is limited only by the claims appended hereto.

What is claimed is:

1. Apparatus for projecting a beam from an excimer laser to form a line of light on a substrate, the beam having a width and a height, and having long-axis aligned with the height of the beam and a short-axis aligned with the width of the beam, the beam being plane-polarized with the polarization plane aligned with the long axis of the beam, the apparatus comprising:
a cylindrical lens having a long axis aligned with the long-axis of the beam, the lens having positive power in the short-axis of the beam and zero optical power in the long-axis of the beam, with the lens being positioned to receive the beam at a non-normal angle of incidence with respect to a normal that lies in a plane parallel to the long axis of the lens and the lens being arranged with respect to the substrate such that the beam is projected by the lens as a line of light on the substrate; and
wherein the line of light has a length longer than the height of the beam and a width less than the width of the beam.

2. The apparatus of claim 1, wherein the angle of incidence of the beam on the cylindrical lens is between about 45° and 85°.

3. The apparatus of claim 1, wherein the angle of incidence of the beam on the cylindrical lens is about equal to the Brewster angle for the material of the substrate.

4. The apparatus of claim 1, wherein the angle of incidence of the beam on the cylindrical lens is between the Brewster angle for the material of the cylindrical lens and the Brewster angle for the material of the substrate.

5. The apparatus as recited in claim 1, wherein the angle of the incidence of the beam on the lens and the angle of incidence of the beam on the substrate are selected to minimize the total reflection loss.

6. The apparatus as recited in claim 1, wherein the lens includes an anti-reflection coating.

7. A method of modifying the original ratio of the width to the height a laser beam reaching a substrate comprising the steps of:
providing a cylindrical lens having a long axis with zero optical power and a short axis with positive optical power, said lens being positioned so that the laser beam passing therethrough will reach the substrate; and
directing the laser beam at a non-normal angle of incidence with respect to a normal that lies in a plane parallel to the long axis of the lens in a manner so that the height of the beam reaching the substrate is increased from the original height and the width of the beam is reduced from the original height and with the angle of incidence being selected to minimize reflection losses at the lens and at the substrate.

8. A method as recited in claim 7, wherein the beam is plane-polarized with the polarization plane being aligned with the height of the beam.

9. A method as recited in claim 8, wherein the angle of incidence of the beam on the cylindrical lens is between about 45° and 85°.
